(19) United States
(12) Patent Application Publication
(10) Pub. No.: US 2025/0241302 A1
(43) Pub. Date: Jul. 31, 2025

(54) PERMANENT DISINFECTANT

(71) Applicants: FLUOS S.A.S. DI GIUSEPPE CHIARADIA & C., Busto Arsizio (VA) (IT); INDUSTRIE GENERALI S.P.A., Samarate (VA) (IT); CHEMCOM INVESTMENTS BV, Farmsum (NL)

(72) Inventors: Giuseppe CHIARADIA, Torino (IT); Dario COLOMBO, Busto Arsizio (VA) (IT); Caterina TURESSO, Busto Arsizio (VA) (IT)

(73) Assignees: FLUOS S.A.S. DI GIUSEPPE CHIARADIA & C., Busto Arsizio (VA) (IT); INDUSTRIE GENERALI S.P.A., Samarate (VA) (IT); CHEMCOM INVESTMENTS BV, Farmsum (NL)

(21) Appl. No.: 18/702,883

(22) PCT Filed: Oct. 18, 2022
(86) PCT No.: PCT/IB2022/059991

§ 371 Date: Apr. 19, 2024

(30) Foreign Application Priority Data
Oct. 20, 2021 (IT) 102021000026909

(51) Int. Cl. A01N 37/06; A01N 25/02; A01N 65/08; A01N 65/12; A01N 65/20; A01P 1/00

(52) U.S. Cl. CPC A01N 37/06; A01N 25/02; A01N 65/08; A01N 65/12; A01N 65/20; A01P 1/00

(57) ABSTRACT

A use and a method of conferring permanent disinfectant properties on a surface of any material by distribution on it of a disinfectant solution made of a mixture of certain lipids with biocidal properties with suitable volatile solvent; wherein after distribution on the surface, the solvent evaporates progressively, leaving a very thin layer of homogeneously arranged lipids on it. This lipid layer renders the surface active in the killing and deactivation of viruses and bacteria. Furthermore, a method for disinfecting a material can be achieved by applying the disinfectant composition to a treated substrate having biocidal activity obtainable with the method.

### Field of the Invention

The present invention relates to the use of a disinfectant composition comprising fatty acids from vegetable oils and/or esters thereof and/or epoxidized esters thereof and/or epoxidized fatty acids from vegetable oils in a volatile carrier solvent capable to make permanently disinfecting the surface on which it is applied after evaporation of the solvent. Furthermore, The invention relates also to a method to make disinfected over time a material by means of said disinfectant composition.

### Background

Pathogens such as viruses and bacteria can remain infectious for several days causing a significant infection risk to anyone touching a contaminated surface both in public environments as well as in domestic areas. Among the most common viruses, respiratory viruses are responsible for more deaths globally than any other infectious agent. For example, coronavirus SARS-CoV-2, which appeared at the beginning of 2020, causes upper respiratory tract infection in healthy individuals and serious disease in patients with comorbidities, and is responsible for the deaths of more than 4,5 million people up to now.

Therefore, the sanitization of materials, clothing and hands is an important prevention activity against the spread of viruses and bacteria. However, after the surface is sanitized, for example by means of an alcohol solution, it is again exposed to the depositing on it of pathogens emitted into the environments by infected people. It follows that periodically the surface must again be subjected to disinfection treatment, and the frequency of treatment is necessarily more intense for hospitals, buildings and public transport.

Moreover, it is known that face masks are one of the most effective protective devices from infection caused by viruses such as SARS-COV-2. However, if appropriate precautions are not taken (for example continuously replacing the mask and/or not touching it with hands), even such a protective device, may represent an infection risk factor for the user. It has been shown that placing the mask on the table or putting it back in the pocket after use greatly increases the risk of infection, as contaminated particles can be transferred to the mask.

There is still a need in the sector to find a suitable way to provide surfaces, such as those of a public or domestic environment, and substrates, such as face masks, with high and effective biocidal properties that can last for a prolonged period to avoid contamination risks over time.

According to the currently available disinfecting treatments, immediately after sanitation, the surface remains exposed to pathogens and therefore potentially infectious, until the subsequent sanitation treatment, which shall thus be frequently repeated.

The present invention solves the problem of making the surfaces of materials active against pathogens by providing a disinfecting composition comprising unsaturated and/or short-chain fatty acids and/or their esters and/or their epoxidized esters in a suitable volatile carrier solvent which, when used on a material, provides biocidal properties to the treated object, and allow such an object to effectively maintain the protection against the pathogens over a prolonged period. The treated surface acquires disinfected properties because after application on the surface of a material, the composition of the invention not only disinfects the surface, but leaves on it a very thin layer of biocidal lipids, which keep the surface permanently active against enveloped viruses and bacteria, by physical action of dissolution of the protective lipid membrane of the micro-organism. This protective coating remains until the lipid micro-layer is removed.

WO2021/175947 discloses a pesticide composition comprising a C₁₂-C₂₄ fatty acid in an emulsion with a vegetal oil and an ethoxylated surfactant or a polyoxyethylene emulsifier, as well as a process for preparing the same and uses for protecting crop against pests. Said composition is not suitable for the purpose of the present invention since the presence of the emulsifier and the surfactant cause the surface, where the composition is spread, to become oily. Therefore, it should be rinsed with the consequence of eliminating the biocidal activity.

U.S. Pat. No. 7,951,766 discloses a bio-based cleaning composition comprising an epoxidized fatty acid ester, optionally with co-solvents or additives. The composition is used in a method of cleaning wherein it is applied to a soiled substrate and then removed with the soil after a predetermined period of time. Accordingly, once removed the soil and the composition, the surface is again exposed to contamination.

US2017/0027169 discloses the use of a surfactant to achieve a wetting layer at the surface of a biofilm. This wetting surface creates the equivalent of a membrane, so that osmotic pressure continues the flow of aqueous solution through the wetting layer. When the raised pH surfactant layer wets the biofilm or microorganism, the result is an increase in pH such that the pH of the surfactant layer exceeds the tritation point of the weak acid. By combining a weak acid with such a surfactant layer, in proper pH-tritation point balance, it is maintained continuous and enhanced protonation in the surfactant layer. In this manner a real disinfection effect is achieved since the defence of the biofilm layer are broken. Therefore, the proposed disinfectant formulation comprises weak acids, glycol mono esters and surfactants. In addition, the disinfection methods are based on the creation of a Ph environment, basic, to kill the micro-organisms.

U.S. Pat. No. 8,772,390 discloses a method of applying a protective polymeric coating that avoids corrosion, comprising mixing a cellulose acetate buterate with a plasticizer and a corrosion inhibitor. No reference to a disinfectant composition is made.

JP2014231666 discloses a water permeability imparting agent for nonwoven cloth of a water-absorbing article such as paper diaper and sanitary napkin. Said agent contains an ester compound selected from the group consisting of coconut oil, palm oil, peanut oil, olive oil, castor oil, rapeseed oil, bran oil, sunflower oil, tallow and train oil with glycerine. No mention of a disinfectant effect is made.

CN104862108 discloses a water-saving automotive glass cleaning fluid prepared from raw materials in parts by weight as follows: 6-14 parts of palm wax, 5-7 parts of linseed oil, 4-9 parts of a solvent D-30, 2-6 parts of glycerin, 4-11 parts of ethyl acetate, 5-10 parts of triethanolamine, 7-9 parts of coconut oil fatty acid, 2-5 parts of an anti-freezing agent, 1-4 parts of naphthenic oil, 2-6 parts of sodium silicate, 3.5-9 parts of sodium sebacate, 4-10 parts of sodium citrate, 2.5-7 parts of polyethylene glycol, 5.4-8 parts of alkylphenol ethoxylates, 1-3 parts of glycerol and 5.6-9 parts of alkenyl sulphonate. Again no mention of a disinfectant activity is made.

Other prior art documents consist in articles disclosing only the characterization of fatty acids (JIA XIAO et al: Identification of key aroma-active compounds in sesame oil from microwaved seeds using E-nose and HS-SPME-GCxGC-TOF/MS, Food Biochemistry, Volume43, Issue10, Special Issue: Chinese Flavor Chemistry, October 2019; IBRAHIM KHALIL et al.: Characterisation of Fatty Acid Contents of Sesanum indicum grown in Nasarawa State, Nigeria using Gas Chromatography,/Elixir Biosci. 76 (2014) 28397-28399; KERR ROBERT et al: Oklahoma Cooperative Extension Service @BULLET Division of Agricultural Sciences and Natural Resources, FAPC-222 FOOD THECNOLOGY FACT SHEET Canola Oil Properties Adding value to OKLAHOMA, 1 Dec. 2018; MEADOWS SHARTORI et al: Comparative Analysis on the Epoxidation of Soybean Oil using Formic and Acetic Acids, Polymers and polymer composites, vol. 26, no. 4, 1 May 2018, pages 289-298).

Accordingly, none of the above publications and patents proposes a method to make permanently disinfectant a surface. All said documents deal with instant disinfection of the material, and none of these discloses a preparation of a certain disinfectant composition, which, after application on the surface of the material, gives that surface biocidal properties that remain until the protective layer is removed. Moreover, none of these indicate the need to include in the composition a volatile solvent which, after application on the surface and subsequent evaporation, makes this surface active in the destruction of the protective membrane of enveloped viruses and bacteria

### SUMMARY OF THE INVENTION

The present invention relates to the use of a disinfectant composition comprising fatty acids from vegetable oils and/or esters thereof and/or epoxidized esters thereof and/or epoxidized fatty acids from vegetable oils in a volatile carrier solvent capable to make permanently disinfecting the surface on which it is applied after removal of the solvent Furthermore, The invention relates also the method to make disinfectant over time a material by means of said disinfectant composition.

Said composition comprises (i) a volatile low boiling point carrier solvent and (ii) a mixture of fatty acids deriving from a vegetable oil and/or esters of said fatty acids and/or epoxidized esters of said fatty acids and/or a mixture of epoxidized fatty acids deriving from a vegetable oil. The vegetable oil is preferably selected from the group consisting of: soybean oil, sunflower oil, rapeseed oil, linseed oil, coconut oil, palm oil, palm kernel oil, olive oil, corn oil, peanut oil, sesame oil, or a combination thereof. The mixture of fatty acids preferably comprises: one or more C₁₆-C₂₂ unsaturated fatty acids, one or more C₆-C₁₂ saturated fatty acids, or combinations thereof.

Preferably, said esters of said fatty acids are obtained by reacting said fatty acids, with:
a) a polyhydric alcohol, preferably glycerol,
b) a glycerol derivative, preferably a cyclic hydroxy acetal, more preferably Glycerol Formal, or
c) an ethoxylated alcohol.

Preferably, said epoxidized esters of said fatty acids are obtained by reacting said fatty acids obtained by hydrolysis of said vegetable oil, with:
a) a polyhydric alcohol, preferably glycerol,
b) a glycerol derivative, preferably a cyclic hydroxy acetal, more preferably Glycerol Formal, or
c) an ethoxylated alcohol, and subsequent epoxidation of the double bonds contained into the hydrocarbon chains of said fatty acids.

The composition capable of making the surface of a material disinfected according to the present invention is used by applying it on at least a surface of a substrate to be disinfected and/or embedding a substrate with the composition, preferably by means of a technique selected from the group consisting of: spraying, immersion, impregnation, coating, or a combination thereof.

Furthermore, the invention relates to a method of conferring permanent disinfectant properties on a surface of any material by distribution on it of a disinfectant solution consisting of a mixture of certain lipids with biocidal properties with suitable volatile solvents. After distribution on the surface, the solvent evaporates progressively, leaving a very thin layer of homogeneously arranged lipids on it. This lipid layer renders the surface active in the killing and deactivation of viruses and bacteria.

The invention also relates to a treated substrate (i.e. a substrate which has been disinfected) having biocidal properties obtainable with the method according to the invention after evaporation of the carrier solvent (i). Said treated substrate is coated on at least one surface thereof with a uniform film and/or is embedded with component (ii) of the disinfectant composition.

According to one embodiment, said film is a layer that is thin and compact.

Preferably the above-mentioned substrate is a substrate made of at least a material selected from the group consisting of: a polymeric material, a glass material, a ceramic material, a wood material, a non-woven fabric, a knitted fabric, a woven fabric, or a combination thereof.

For example, said polymeric material is selected from the group consisting of: PVC, polyamide, polyurethanes, phenolic resins, polyester resins, or a combination thereof.

Preferably said substrate is an object, a tool, a medical device, a furnishing of a house, a building, or an environment, including floors and walls. The present invention also relates to the disinfectant composition as described above and to its use in disinfecting a part of the human body, preferably hands and/or arms.

### BRIEF DESCRIPTION OF THE DRAWINGS

FIG. 1 shows the standard plaque formation assay for the determination of the antiviral activity of different disinfectant solutions, after 5 hours of incubation. Sample designation: Fatty acids obtained from hydrolysis of soy oil 10% wt.: spray 1; Epoxidized fatty acids from soy oil 10% wt.: spray 2; Epoxidized fatty acids from soy oil 5% wt.: gel 1; Epoxidized fatty acids from soy oil 2.5% wt., GDE epoxyester 2.5% wt.: gel 2; commercial disinfectant gel: commercial gel.

FIG. 2 shows the ability of surgical masks pretreated with sprays to completely inhibit HSV-1 replication, starting from 30 minutes of virus adsorption.

FIG. 3 shows the results of an antibacterial assay performed to evaluate the effect of different solutions/gel on S. aureus and E. coli growth at 5 hours, after 30 minutes of drying.

FIG. 4 shows the results of an antibacterial assay to evaluate the effect of different solutions on S. aureus and E. coli growth at 5 hours, after 18/24 hours of drying.

Untreated bacteria (indicated as-) was used as control of bacterial growth. Colonies were counted and the mean was expressed as total CFU. The results are reported as mean ±SEM of total CFU performed in duplicate.

### DETAILED DESCRIPTION OF THE INVENTION

For the purposes of the present invention, “disinfectant composition” refers to a composition able to destroy or inactivate pathogens.

For the purposes of the present invention the term “pathogens” refers to bacteria, fungi, spores, viruses, or mycobacteria.

For the purposes of the present invention, “biocidal agent” means an agent having bactericidal and/or fungicidal and/or sporicidal and/or virucidal and/or mycobactericidal activity.

For the purposes of the present invention, the terms “film” and “layer” are used as synonyms.

According to the present invention the expression “epoxidized fatty acid” refers to a saturated fatty acid wherein the double bonds contained into the hydrocarbon chains of said fatty acid are epoxidized.

For the purposes of the present invention, the expressions “esters of epoxidized fatty acids”, “epoxidized esters of fatty acids” or “epoxyesters of fatty acids” are used as synonyms.

For the purposes of the present invention “fatty acids deriving from a vegetable oil”, can also be referred to as “fatty acids of a vegetable oil”, “fatty acids from a vegetable oil” or similar expressions.

For the purposes of the present invention “epoxidized fatty acids deriving from a vegetable oil”, can also be referred to as “epoxidized fatty acids of a vegetable oil”, “epoxidized fatty acids from a vegetable oil” or similar expressions.

According to the present invention, “soybean oil” or “soy oil” are used as synonyms.

Glycerol formal is obtained by reaction of glycerol and formaldehyde and could be defined as a cyclic hydroxy-acetal: this term is herein to be intended as indicating an acetal with an hydroxy function. It is composed by two isomers: 1,3 Dioxane-5-ol (isomer with rings of 6 atoms) and 1,3 Dioxane-4-methanol (isomer with ring of 5 atoms). The structure of the two isomers is the following:

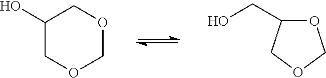 [SMILES: OC1COCOC1 ; OCC1COCO1]

In particular, glycerol formal is obtained by reaction of glycerol and formaldehyde, and the isomers are produced with similar quantities (the isomer with six atoms, which is more stable, is formed with a slightly higher quantity).

The present invention relates to the use of a disinfectant composition as a biocidal (i.e. virucidal, bactericidal, fungicidal and/or mycobactericidal) agent having the ability to form a thin layer of certain lipids with biocidal properties adhering to the treated surface.

The disinfectant composition comprises the following two components:
(i) A volatile low boiling carrier solvent; and
(ii) A mixture of fatty acids deriving from a vegetable oil and/or esters of said fatty acids and/or epoxidized esters of said fatty acids and/or a mixture of epoxidized fatty acids deriving from a vegetable oil.

According to one embodiment of the present invention, said vegetable oil is preferably selected from the group consisting of: soybean oil, sunflower oil, rapeseed oil, linseed oil, coconut oil, palm oil, palm kernel oil, olive oil, corn oil, peanut oil, sesame oil, or a combination thereof.

According to one embodiment, said mixture of fatty acids comprises: one or more C₁₆-C₂₂ unsaturated fatty acids, preferably one or more C₁₆-C₁₈ unsaturated fatty acids, one or more C₆-C₁₂ saturated fatty acids, or combinations thereof.

According to an embodiment said carrier solvent (i) is a solvent which is able to solubilize fatty acids and/or esters of fatty acids and/or epoxidized esters of fatty acids and/or epoxidized fatty acids, having a low boiling temperature below 100° C.

For example, said carrier solvent (i) is a C₁-C₅ linear or branched alcohol.

According to another embodiment of the present invention, the disinfectant composition consists essentially of the above-mentioned two components (i) and (ii).

According to another alternative embodiment of the invention, the disinfectant composition consists of the above-mentioned two components (i) and (ii).

According to one embodiment, said carrier solvent (i) is a C₁-C₅ linear or branched alcohol selected from the group consisting of: methyl alcohol, ethyl alcohol, 1-propanol, isopropyl alcohol, n-butanol, isobutanol, tert-butyl alcohol, 1-pentanol, neopentyl alcohol, 2-pentanol, 3-pentanol, or a combination thereof.

Preferably, according to any one of the embodiments recited above, said carrier solvent (i) is ethyl alcohol because in addition to carrying out the action of volatile solvent allows to contribute to the immediate disinfecting of the surface together with the lipid. In other words, it has been observed a synergic effect between the two components.

According to one embodiment of the present invention said mixture of fatty acids is a mixture of one or more of C₁₆-C₂₂ unsaturated fatty acids and one or more of C₆-C₁₂ saturated fatty acids.

According to a preferred embodiment, said mixture of fatty acids is a mixture of one or more of C₁₆-C₁₈ unsaturated fatty acids and one or more of C₆-C₁₂ saturated fatty acids.

Preferably, said mixture of fatty acids comprises at least: linoleic acid, linolenic acid, oleic acid.

Preferably said mixture of fatty acids comprises also lauric acid.

Preferably, the mixture of fatty acids according to the present invention is obtained by hydrolysis of said vegetable oil.

Preferably said mixture of epoxidized fatty acids derives from epoxidation of the double bonds contained into the hydrocarbon chains of one or more of C₁₆-C₂₂ unsaturated fatty acids, preferably of one or more of C₁₆-C₁₈ unsaturated fatty acids.

Preferably, said mixture of epoxidized fatty acids comprises at least: epoxidized linoleic acid, epoxidized linolenic acid and epoxidized oleic acid.

Preferably, said esters of said fatty acids are esters of said mixture of fatty acids.

According to an embodiment, said esters are obtained by reacting said fatty acids, obtained by hydrolysis of said vegetable oil, with:
a) a polyhydric alcohol, preferably glycerol,
b) a glycerol derivative, preferably a cyclic hydroxy acetal, more preferably Glycerol Formal, or
c) an ethoxylated alcohol.

Preferably, said epoxidized esters of said fatty acids are epoxidized esters of said mixture of said fatty acids.

According to an embodiment, said epoxidized esters are obtained by reacting said fatty acids obtained by hydrolysis of said vegetable oil, with:
a) a polyhydric alcohol, preferably glycerol,
b) a glycerol derivative, preferably a cyclic hydroxy acetal, more preferably Glycerol Formal, or
c) an ethoxylated alcohol, and subsequent epoxidation of the double bonds contained into the hydrocarbon chains of said fatty acids.

According to this embodiment, the mixture of fatty acids to be esterified and then epoxidized, comprises one or more of C₁₆-C₂₂ unsaturated fatty acids, preferably one or more of C₁₆-C₁₈ unsaturated fatty acids.

According to a preferred embodiment, component (ii) is a mixture of fatty acids as described above.

According to another preferred embodiment, component (ii) is a mixture of epoxidized fatty acids as described above.

According to another embodiment, component (ii) comprises:
a mixture of fatty acids, and
esters of said mixture of fatty acids, as described above.

According to another embodiment, component (ii) comprises:
a mixture of epoxidized fatty acids, and
epoxidized esters of said mixture of fatty acids, as described above.

According to a preferred embodiment the present invention, the mixture of fatty acids and/or the mixture of epoxidized fatty acids as described above has the advantageous feature of being completely of renewable origin since the mixture of fatty acids and/or epoxidized fatty acids derives from a naturally occurring vegetable oil.

According to a preferred embodiment of the present invention, wherein the esters and/or epoxidized esters of said mixture of fatty acids are obtained by reacting said fatty acids with glycerol, also in this case component (ii) has the advantageous feature of being completely of vegetable origin since glycerol is a by-product of biodiesel production.

In the case the reaction is carried out with a derivative of glycerol such as Glycerol Formal, about 96% of these esters and/or epoxidized ester are of natural origin.

This is because glycerol formal has the feature of being almost completely of vegetable origin. In this case, since glycerol formal is obtained from glycerol by reaction with formaldehyde, the non-vegetable origin portion derives only from the latter.

According to the present invention, the preferred vegetable oil is selected from the group consisting of soybean oil, sunflower oil, rapeseed oil, linseed oil, coconut oil, palm oil, palm kernel oil, olive oil, corn oil, peanut oil, sesame oil, or a combination thereof. Soybean oil is particularly preferred as it is one of the most common naturally occurring vegetable oil and has a high content of saturated fatty acids.

The preferred mixture of fatty acids deriving from the vegetable oils according to the present invention comprises linoleic acid, linolenic acid, oleic acid.

The main unsaturated fatty acids composition of some vegetable oils according to the present invention with the relative concentrations is shown in the following table (Table 1).

TABLE 1

| Fatty | | Soybean | Sunflower | Rapeseed | Linseed |
|---|---|---|---|---|---|
| acids | * | % wt. | % wt. | % wt. | % wt. |
| Poly- | Linoleic | 48-52% | 50-70% | 15-25% | 14-19% |
| unsaturated | acid (C18:2) | | | | |
| | Linolenic | 7-10% | 0.2-2% | 8-11% | 48-60% |
| | acid (C18:3) | | | | |
| Mono- | Oleic acid | 19-30% | 14-24% | 45-70% | 14-24% |
| unsaturated | (C18:1) | | | | |

* The first number following the symbol C is the number of carbon atoms and the second the double bonds in the hydrocarbon chain.

According to another embodiment, the mixture of fatty acids deriving from the vegetable oils according to the present invention also comprises lauric acid, which preferably derives from coconut oil.

According to an embodiment of the present invention, the disinfectant composition comprises:
0.1 to 99.9% wt., of component (i),
   and
at least 0.1% wt. of component (ii).

Preferably, the disinfectant composition comprises:
0.1 to 99.7% wt., of component (i),
   and
at least 0.1% wt. of a mixture of fatty acids deriving from a vegetable oil and/or at least 0.1% wt. of esters of said fatty acids and/or at least 0.1% wt. of epoxidized esters of said fatty acids, and/or a mixture of epoxidized fatty acids deriving from a vegetable oil (component (ii)).

Preferably, the disinfectant composition comprises:
90-95% wt. of component (i),
   and
5-10% wt. of component (ii).

Preferably, the disinfectant composition is formulated as a solution, gel or emulsion W/O or O/W. As a thickener in emulsions can be used guar gum, xhantan gum, polyacrylates or any other polymer suitable for this purpose.

According to a preferred embodiment of the present invention, the disinfectant composition is used by applying said disinfectant composition on at least a surface of a substrate to be disinfected and/or embedding a substrate with the disinfectant composition.

Preferably the use of the disinfectant composition according to an embodiment of the present invention is carried out by means of a technique selected from the group consisting of: spraying, immersion, impregnation, coating, or a combination thereof.

Preferably said substrate is an object. Said object is preferably selected from the group consisting of: a device, preferably a medical device, a tool, a furnishing piece, a piece of clothing, preferably a laboratory coat, a uniform, a facial mask, preferably a surgical mask, a FPP2 mask or a FPP3 mask.

Preferably, said substrate is made of at least a material selected from the group consisting of: a polymeric material, a glass material, a ceramic material, a wood material, a non-woven fabric, a knitted fabric, a woven fabric, or a combination thereof.

Preferably, said polymeric material is selected from the group consisting of: PVC, polyurethanes, phenolic resins, polyesters resins, or a combination thereof.

According to another embodiment, said substrate is a closed environment.

Preferably said closed environment is a room. More preferably said closed environment is a closed environment of a building, preferably a house, a hospital, a school, of a vehicle, a train, a plane, or a boat.

In this case, the disinfectant composition can be applied to any surfaces and/or objects contained in said closed environment, preferably by means of the abovementioned techniques.

For example, the disinfectant composition according to the present invention can be applied to the floor and/or the walls and/or the piece of furniture of a room of a building, and/or the accessorize of a vehicle, for example the woven or non-woven fabric of the seats, belts, steering wheel etc.

The present invention also relates to a method for make permanently disinfectant the surface of a material comprising the following steps:
a) Providing a material to be disinfected, preferably said substrate being as described above;
b) Applying a disinfecting composition on the surface of said material, preferably by means of a technique selected from the group consisting of: spraying, coating, or a combination thereof, wherein said disinfecting composition is as described above, and/or b1) embedding said material with the disinfecting composition, preferably by means of a technique selected from the group consisting of:
   immersing, impregnating, or a combination thereof;
c) evaporating the carrier solvent (i), by waiting for a suitable drying time at ambient temperature, thus realizing a treated material.

Said treated material has been disinfected according to the method of the present invention and, advantageously, has a permanent biocidal activity.

Possibly said drying time can be reduced further by blowing air with a fan or by heating.

If an excess of disinfectant mixture occurs, this can be removed by light mechanical rubbing with a cloth or suction systems on the flat surfaces or letting it to leak away by gravity for inclined or suspended surfaces. In any case, even after the optional removal of the excess of the disinfectant mixture, a thin layer of the mixture adheres to the treated surface and, because the solvent has a low boiling point, it evaporates quickly leaving an even thinner lipid layer.

It is very important to notice that advantageously after the evaporation of the solvent, the presence of the lipid layer is visually almost imperceptible; it is only noticeable that the surface appears glossier than the untreated one by observing it from appropriate angles. In any case, after proper application the surface does not appear greasy; in fact, it appears that thanks to the composition of the present invention, after evaporation of the solvent the lipids modify their distribution to organize themselves on the treated surface so that to obtain said thin layer which is not only non-greasy but above all is permanently adhering in an active disinfecting structure.

Without wishing to be bound to a specific theory, it is possible to argue that the biocidal activity of the treated substrate obtainable by means of the method of the present invention according to steps a), b) and c) is related to the formation of a lipid layer which is advantageously uniform and continuous. Such a thin-lipid layer is formed on at least one surface of the treated substrate after application of the disinfectant composition according to the invention and subsequent evaporation of the carrier solvent (i). Such a uniform and continuous lipid layer is formed by the molecules of component (ii) (i.e. fatty acids and/or their esters and/or their epoxidized esters and/or epoxidized fatty acids) which exert a disintegrating or destabilizing action against the cellular membranes of the pathogens as enveloped viruses and bacteria resulting in prolonged biocidal activity of the surface of the substrate coated with such a lipid layer.

For example, according to an embodiment of the present invention, said a prolonged biocidal activity is a biocidal activity which lasts for at least 1 hour, at least 2 hours, at least 4 hours, at least 5 hours, preferably for at least 12 hours, more preferably for at least 24 hours.

In the case of the treated substrate obtainable by means of the method of the present invention according to steps a), b1) and c), the biocidal activity is related to the presence of molecules of the component (ii) which are absorbed and/or embedded within the molecules forming the material, after evaporation of the carrier solvent (i). In the case, for example, of a woven, non-woven, or knitted fabric substrate, said molecules are found within the weave of said fabric. In the case of a material with an adequate porosity, said molecules can also be found within the pores of that material. As above, such molecules of component (ii) can exert a disintegrating or destabilizing action on the membranes of pathogens resulting in a prolonged biocidal activity of the treated material.

In the case of the treated material obtainable by means of the method of the present invention according to steps a), b), b1) and c), a similar reasoning as above applies.

The present invention also relates to a disinfectant composition comprising components (i) and (ii) according to any one the embodiments described above.

According to an embodiment of the invention, the disinfectant composition consists essentially of or consists of said components (i) and (ii).

Another object of the present invention is the disinfectant composition according to any one of the embodiments described above for use in disinfecting a part of the human body.

Preferably said part of the human body is the skin, and is selected from the skin of hands, arms etc.

Preferably, said disinfectant composition is applied to said part of the human body and distributed so as to uniformly cover it.

Without wanting to be bound to a specific theory, the Applicant has found that the disinfectant composition according to the present invention, when used on a material, allows the treated substrate to have biocidal properties and to maintain them over time, which can preferably vary from a few hours, for example for the skin of the human hands, to a few weeks, for example for inert and non-porous materials.

It can be envisaged that such a prolonged protection against pathogens is connected to the presence of the molecules component (ii) of the disinfectant composition, which exert a disintegration or destabilization action by dissolving the plasma membrane of pathogens, preferably enveloped viruses and/or bacteria, thus resulting in their deactivation. Even the simple destabilization of the membrane can indeed reduce the efficiency of contagion of the pathogen agent, as anchoring to the host cell is more difficult.

In the case of the treatment of human skin it is appropriate to use disinfectant mixtures in the form of a gel or emulsion. In such a case as an emulsifying agent, a polysaccharide such as xanthan gum, guar gum, etc. or a polyacrylate can be used.

### EXAMPLES

The ability to maintain the antiviral activity of a surface of an inert material (such as glass) coated with the disinfectant composition according to the present invention following the method comprising steps a), b) and c), was evaluated.

The solvent carrier (i) of the disinfectant composition chosen for evaluation was ethyl alcohol. Since ethyl alcohol has high vapour pressure (boiling temperature of 78,4° C.), after about ten minutes of exposure to air, ethyl alcohol evaporates almost completely, leaving a thin and coherent lipid layer formed by the molecules of component (ii).

For the evaluation, the following different components (ii) were chosen:
1. Fatty acids obtained from hydrolysis of soy oil,
2. Epoxidized Fatty acids from soy oil
3. Epoxidized esters of fatty acids from soy oil obtained by reacting said fatty acids obtained from hydrolysis of soy oil with Glycerol Formal and subsequent epoxidation of the double bonds contained into the hydrocarbon chains of said fatty acids (hereinafter identified as GDE epoxyester).

In more detail, the evaluation consisted in distributing on the bottom of a cylindrical glass well with a diameter of 2 cm a mixture in ethyl alcohol of component (ii) by means of a sterile cotton stick and left to dry under a sterile hood for 24 hours. The lipid (i.e. fatty acids) concentration was between 5-10% wt. After leaving the treated surface exposed to air for 24 hours, a test was done to verify the anti-viral properties of the surface.

The results of tests on the antiviral properties of the surfaces treated with the disinfectant composition comprising different components (ii) listed above indicate that the surface after 24 hours retains the anti-viral properties.

Without wanting to be bound to a specific theory it can be argued that the evaporation of ethyl alcohol, which performs the function of carrier, allowed the remaining lipids (i.e. fatty acids and/or esters thereof and/or epoxidized esters thereof) to be distributed homogeneously over the entire surface of the substrate.

In this way the treated surface was covered by a thin lipid veil a few microns thick, but sufficient to dissolve the membrane of bacteria and in particular of viruses, whose diameters are generally not more than 100 nm.

Evidently, as long as a lipid layer remains on the treated surface, this surface keeps its activity intact. For non-porous inert surfaces, given the non-volatility of these compounds (for example, oleic acid boiling temperature=360° C.), the biocidal efficiency can remain for several days. However, mechanical rubbing and the need for surface cleaning procedures involve the partial or total removal of the lipid protective layer. Even the natural evaporation of the lipid, despite its very low vapor pressure determines over time a thinning of the lipid layer. Consequently, the treatment must be repeated on the basis of the extent of mechanical rubbing or the required sanitizing frequencies of the surfaces.

### Example 1—Evaluation of the Viral Replication

The aim of these tests was to evaluate viral replication on some solutions and gels in ethyl alcohol of different components (ii) of the disinfectant composition of the present invention. Plastic surfaces and surgical masks fabric were coated with sprays and/or gels and were evaluated for the antiviral activity.

Herpes simplex virus type 1 (HSV-1) was used as a viral model. It is a ubiquitously spreading virus, belonging to the Herpesviridae family, with a double-stranded genome (ds) of DNA. It features a protein coating (capsid) and an additional outer phospholipid double layer (pericapsid). It was therefore used as a prototype of a “coated” (i.e. “enveloped”) virus.

### Preparation of Viral Stock

HSV-1 stocks used for the experiments were prepared by infecting African Green Monkey kidney cells (VERO), grown in Dulbecco's Modified Eagle's Medium (DMEM) soil, added supplemented with 10% bovine foetal bovine serum (FBS). After the appearance of the full cytopathic effect (CPE), cells and supernatants were harvested, pooled, and then lysed by three freeze-thaw cycles. After the appearance of a complete cytopathic effect, the cells and rounds were collected and lysed with three freeze-thawing cycles (nitrogen/37° C.). The virus has been lysed and stored at −80° C. The virus-containing liquid was aliquoted and stored at −80° C. Virus titers were assessed by the standard plaque method on fully confluent VERO cells in 96-well plates. The viral suspension was serially diluted in a complete growth medium and inoculated; infections were then carried out at 37° C. for 48 hours. After incubation, the plates were fixed and stained with a 0.1% crystal violet solution, and the cytopathic effect (CPE) was scored by observation under an inverted microscope. The viral titer was calculated as Plaque Forming Units (PFU):

$$Viral title ( PFU / mL ) = number of plaques * 0.1 mL / dilution factor$$

### Experimental Samples

The following samples were used for antiviral activity assays (Table 2).

TABLE 2

| Sample | Description |
|---|---|
| Fatty acids from soy oil 10% wt. | Solution - Spray 1 |
| Ethyl alcohol 90% wt. | |
| Epoxidized fatty acids from soy oil 10% wt. | Solution - Spray 2 |
| Ethyl alcohol 90% wt. | |
| Epoxidized fatty acids from soy oil 5% wt. | Gel 1* |
| Ethyl alcohol 95% wt. | |
| Epoxidized fatty acids from soy oil 2.5% wt. | Gel 2* |
| GDE epoxyester 2.5% wt. | |
| Ethyl alcohol 95% wt | |
| Commercial disinfectant gel | Commercial gel |

*1% Guar Gum was added to Gel 1 and Gel 2 as a thickener.
** GDE is abbreviation to identify a soy epoxidized fatty acid of Glycerol Formal

### Methodology

For plastic surface coating, the solutions and gels were distributed on the bottom of a 24-well plate well by means of a sterile cotton stick and left to dry under a sterile hood for 24 hours. The next day, they were added with 300 μl of viral inoculum (containing more than 109 PFU/mL), centrifuged at 2000 rpm for 15 minutes, to promote virus adsorption at the well and incubated at room temperature for the established timing.

For fabrics, surgical masks, previously sterilized by UV-B light (10 min per side), were treated with spray compound, cut in circular pieces placed on the bottom of a 24-well plate well, and allowed to dry under a sterile hood for 20 hours. The next day, they were inoculated with 250 μl of HSV-1 (containing more than 107 PFU/mL) and incubated at room temperature for the established times.

Samples were collected after gentle scratching of the matrix to remove the adsorbed viral particles and 100 μl of sample were used for the determination of viral titer by standard plaque formation assay, as described above.

### Results

To determine the antiviral activity of different solutions, 100 μl of sample containing HSV-1, obtained after the indicated times of adsorption on the matrices, were analysed by means of the standard plaque formation assay, carried out as described previously. The untreated virus (called “HSV-1 control”) was used as a positive control.

Infection plaques were counted under a microscope and the mean value expressed as plaque forming unit/mL (PFU/mL).

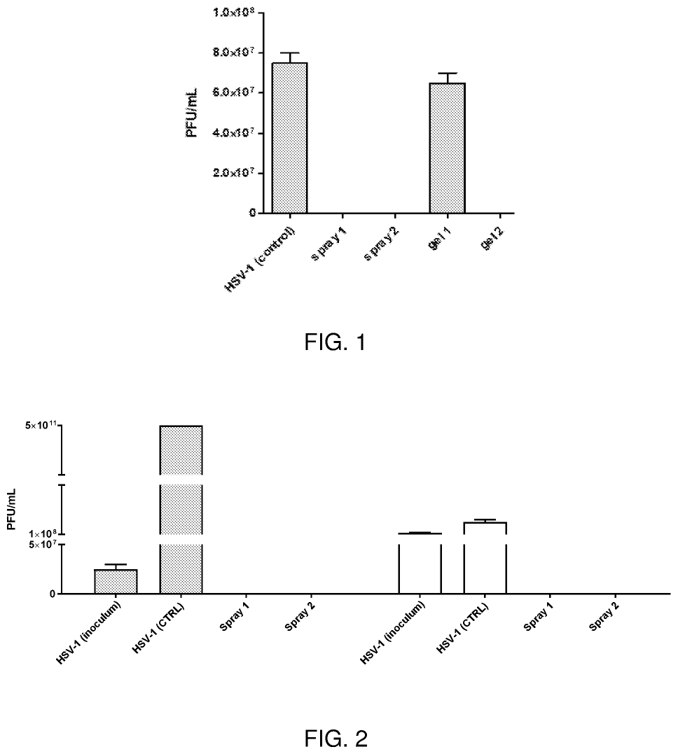

FIG. 1 shows the results (PFU/mL) of an experiment, titrated in duplicate.

The results obtained highlighted the ability of solution spray 1 (with 10% wt. fatty acids obtained from hydrolysis of soy oil), spray 2 (with 10% wt. epoxidized fatty acids from soy oil) and gel 2 (with 2.5% wt epoxidized fatty acids from soy oil and 2.5% wt of GDE epoxyester) to completely inhibit the replication of HSV-1 after 24 hours after treatment and 5 hours of adsorption of the virus.

FIG. 2 shows the ability of surgical masks pretreated with sprays to completely inhibit HSV-1 replication, starting from 30 minutes of virus adsorption.

### Example 2—Antibacterial Activity of a Treated Surface of an Inert Material

Tests were performed to evaluate the effect on the bacterial growth of some solutions and gels in ethyl alcohol of different components (ii) of the disinfectant composition of the present invention. Staphylococcus aureus (ATCC 29213) and Escherichia coli (ATCC 25922) were used as bacterial models of Gram positive and Gram negative bacteria, respectively.

### Bacterial Stock Preparation

All the strains used in the project were cultured on specific agar media, and young colonies (18-24 h) were inoculated into cryovials and maintained at −80° C. for extended storage.

### Experimental Samples

The following samples were used for antibacterial activity assays (Table 3):

| Sample | Description |
|---|---|
| Fatty acids from soy oil 10% wt. | Solution - Spray 1 |
| Ethyl alcohol 90% wt. | |
| Epoxidized fatty acids from soy oil 10% wt. | Solution - Spray 2 |
| Ethyl alcohol 90% wt. | |
| Epoxidized fatty acids from soy oil 5% wt. | Gel 1* |
| Ethyl alcohol 95% wt. | |
| Epoxidized fatty acids from soy oil 2.5% wt. | Gel 2* |
| GDE epoxyester 2.5% wt. | |
| Ethyl alcohol 95% wt. | |

*1% Guar Gum was added to Gel 1 and Gel 2 as a thickener.
** GDE is abbreviation to identify a soy epoxidized fatty acid of Glycerol Formal

### Methodology

Bacteria were cultured overnight at 37° C. in Mueller Hinton Broth (MHB; Becton Dickinson and Company, USA). After incubation, bacteria were centrifuged at 4,000 rpm for 10 min, and the pellet re-suspended in 100 μl of MHB and then diluted in MHB to 102 CFU/ml, as confirmed by colony counts on Mueller Hinton Agar (MHA; Becton Dickinson and Company, USA). The solutions and gels were distributed on the bottom of a 12-well plate: in detail, spray 1 and 2 were applied and the excess was wiped off with a sterile cotton swab; gel 1 and 2 were distributed with a sterile cotton swab. All samples were left to dry under a sterile hood for 18/24 hours or for 30 minutes; then, they were covered with 102 bacterial suspension and the plate was incubated for 5 h at 37° C. Controls represented by bacteria at the same inoculum incubated in MHB with no material, were also performed. The total number of bacteria was quantified by plating on MHA to obtain CFU/ml. All experiments were performed simultaneously for each material, assayed in duplicate.

### Results

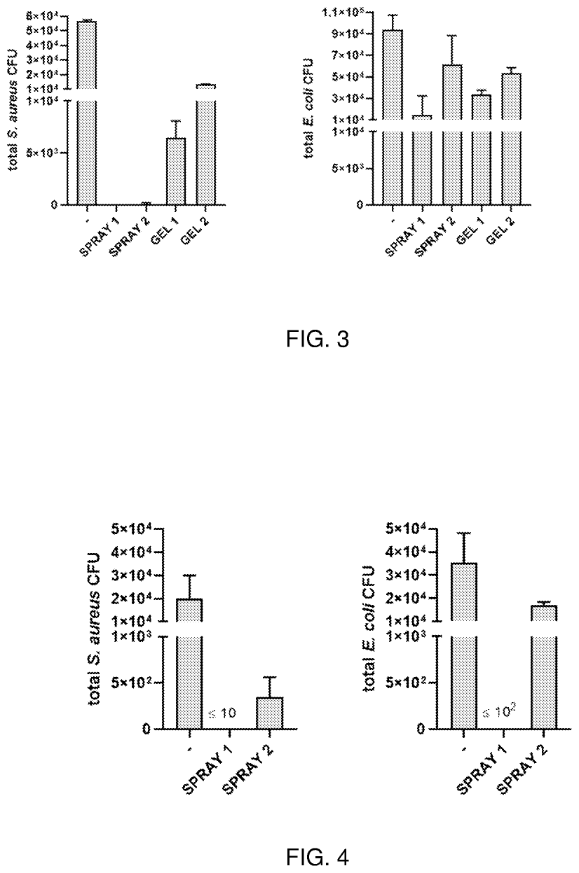

FIG. 3 shows the results of an antibacterial assay performed to evaluate the effect of different solutions/gel on S. aureus and E. coli growth at 5 hours, after 30 minutes of drying. Untreated bacteria (indicated as-) was used as control of bacterial growth. Colonies were counted and the mean was expressed as total CFU. The results are reported as mean ±SEM of total CFU performed in duplicate. In the evaluation of the samples after 30 minutes of drying, spray 1 shows a strong antimicrobial activity on S. aureus and reduces the growth of E. coli by 1 log; spray 2 and gel 1 only affect S. aureus, reducing its growth by 2 log and 1 log, respectively. Instead, there is no effect of gel 2 on both strains.

FIG. 4 shows the results of an antibacterial assay performed to evaluate the effect of different solutions/gel on S. aureus and E. coli growth at 5 hours, after 18/24 hours of drying. Untreated bacteria (indicated as-) was used as control of bacterial growth. Colonies were counted and the mean was expressed as total CFU. The results are reported as mean ±SEM of total CFU performed in duplicate. As shown in FIG. 3, after 18/24 hours of drying, spray 1 confirms its antimicrobial activity on both S. aureus and E. coli, causing a net reduction in the growth of Gram-positive and a 2 log reduction in Gram-negative bacterial growth. Spray 2 results in a 2 log reduction of S. aureus, but shows no relevant effects on E. coli.

### Comments on the Results of the Examples

For the examples, soya fatty acid and the relative epoxidized fatty acid as such or esterified with Glycerol Formal were used. This choice was made because soya fatty acid is rich in unsaturated acids, in particular linoleic, which is known to be very effective in antiviral and anti-bacterial activity.

According to the present invention, it has been found that the fatty acids as such were unable to enter the intertwining of bonds of the polysaccharides that make up the gel, separating into micro droplets. Instead, it has been found that the relative epoxidized fatty acid of the invention was able to form gels without separate phases.

The anomalous data of Gel 1 on viruses (FIG. 1) can be explained by the fact that the hydrogen bonds of the epoxidized fatty acid with the polysaccharide were so strong that the mobility of the molecule was impeded and consequently unable to fit inside of the plasmatic membrane of the microorganism.

The results of Gel 1 and 2 on bacteria (FIG. 3) indicate a lower efficacy compared to the results on viruses. This fact can be explained by considering that bacteria are larger than viruses, on average 1 micrometre in diameter, while enveloped viruses has an average of 0.1 micrometre, and moreover bacteria have a more compact and sophisticated organization of the lipid barrier than that of viruses. The combination of these two factors determines a better compactness of the protective lipid barrier of the bacteria.

Another observation on the tests carried out with gels. Those referring to viruses (FIG. 1) are in contrast with those referring to bacteria (FIG. 3). In fact, the results show that Gel 1 is not effective against viruses, while it has a good activity against bacteria. On the other hand, Gel 2 is very active against viruses and less effective against bacteria than Gel 1. These inconsistencies could be explained by considering that lipids have the ability not only to disorganize the protective lipid structure of bacteria, but also to alter certain metabolisms of bacterial cells (e.g. inhibiting the production of exotoxin). This fact could explain the difference in results between tests performed with viruses and those with bacteria.

It also must be borne in mind that the test data refer to an experimental environmental context that is completely different from that of everyday condition. This experimental environment is favourable to the survival of the bacterium or virus as the solution that contained the micro-organism remains in the well for the 5 hours of the test. This means that above the particles lying on the bottom they are still solvated and surrounded by a layer of water molecules that act as a “buffer”, avoiding direct contact with the lipid surface.

In reality, the context is completely different, the pathogens are dispersed in droplets of saliva or other biological liquids and splashes of blood that are deposited on the surface of the material. Due to the low thickness of the liquid layer and the high surface/volume ratio that favours the rapid evaporation of water, the already scarce aqueous environment surrounding the bacterial cell tends to further reduce. Therefore the bacteria or virus particles will preferably be in direct contact with the surface of the material covered for 100% by a micro-layer of lipid molecules, rather than with the surrounding aqueous environment. This “drowning” of the particle in a lipid carpet facilitates the interaction between the lipid membranes and lipids present on the surfaces, with consequent destruction of the pathogen by disintegration of the membrane.

1. A method for using a disinfectant composition comprising:
obtaining a disinfectant composition, wherein the disinfectant composition comprises:
(i) a low boiling point carrier solvent; and
(ii) a mixture of fatty acids deriving from a vegetable oil and/or esters of the fatty acids and/or epoxidized esters of the fatty acids, and/or a mixture of epoxidized fatty acids deriving from a vegetable oil;
wherein the mixture of fatty acids comprises: one or more C₁₆-C₂₂ unsaturated fatty acids; and
applying the disinfecting composition as a virucidal and bactericidal agent capable on the surface of a material, to make that surface active in the destruction of pathogens agents as viruses and bacterial for a prolonged time.

2. The method according to claim 1, wherein the vegetable oil is selected from the group consisting of: soybean oil, sunflower oil, rapeseed oil, linseed oil, coconut oil, palm oil, palm kernel oil, olive oil, corn oil, peanut oil, sesame oil, or a combination thereof.

3. The method according to claim 1, wherein the esters are obtained by reacting the fatty acids with:
a) a polyhydric alcohol;
b) a 4ydroxyl-acetal; or
c) an ethoxylated alcohol.

4. The method according to claim 1, wherein the mixture of fatty acids comprises at least: linoleic acid, linolenic acid, oleic acid, and/or lauric acid, and/or wherein the mixture of epoxidized fatty acids comprises at least: epoxidized linoleic acid, epoxidized linolenic acid and epoxidized oleic acid.

5. The method according to claim 1, wherein the disinfectant composition is formulated as a solution, gel, or emulsion.

6. The method according to claim 1 by applying the disinfectant composition on at least a surface of a material to be treated and/or by embedding a substrate with the composition.

7. A method for making permanently disinfectant a material comprising:
a) providing a material to be disinfected;
b) applying a disinfecting composition to at least one surface of the material by means of a technique selected from the group consisting of: spraying, coating, or a combination thereof, the disinfecting composition comprising:
(i) a low boiling point carrier solvent; and
(ii) a mixture of fatty acids deriving from a vegetable oil and/or esters of the fatty acids and/or epoxidized esters of the fatty acids and/or a mixture of epoxidized fatty acids deriving from a vegetable oil, wherein the mixture of fatty acids comprises: one or more C₁₆-C₂₂ unsaturated fatty acids, and/or
b1) embedding the substrate with the disinfecting composition;
c) evaporating the carrier solvent (i) by waiting for a suitable drying time at ambient temperature or by heating the substrate, so that to let a thin and compact lipid layer to organize on the substrate to confer a permanent biocidal activity.

8. The method according to claim 7, wherein the material is made of at least a material selected from the group consisting of: a polymeric material, a glass material, a ceramic material, a wood material, a nonwoven fabric, a knitted fabric, a woven fabric, or a combination thereof.

9. The method according to claim 7, wherein the material is selected from the group consisting of: an object or a closed environment.

10. Method of using a disinfectant composition comprising:
obtaining a disinfectant composition comprising:
(i) a low boiling point carrier solvent; and
(ii) a mixture of fatty acids deriving from a vegetable oil and/or esters of the fatty acids and/or epoxidized esters of the fatty acids, and/or a mixture of epoxidized fatty acids deriving from a vegetable oil;
wherein the mixture of fatty acids comprises: one or more C₁₆-C₂₂ unsaturated fatty acids; and
using the disinfectant composition as a permanent virucidal and bactericidal agent able to activate a surface in the destruction of pathogens for a prolonged time.

11. (canceled)

12. A permanent disinfectant composition comprising:
(i) a low boiling point carrier solvent selected from the group consisting of: C₁-C₅ linear or branched alcohol, capable of solubilizing or dispersing lipids; and
(ii) a mixture of fatty acids deriving from a vegetable oil and/or esters of the fatty acids and/or epoxidized esters of the fatty acids and/or a mixture of epoxidized fatty acids deriving from a vegetable oil, wherein the mixture of fatty acids comprises: one or more C₁₆-C₂₂ unsaturated fatty acids.

13. A composition according to claim 12, further a thickening agent.

14. A composition according to claim 12, for use in disinfecting the skin of a part of the human body.
